(19) United States
(12) Patent Application Publication
(10) Pub. No.: US 2011/0277611 A1
(43) Pub. Date: Nov. 17, 2011

(54) WORKING TOOL ADAPTED FOR USE WITH AN OSCILLATING POWER TOOL

(75) Inventors: Zhiguo Chen, Nanjing (CN); Baijun Zhang, Nanjing (CN); Jiyu Zhang, Nanjing (CN)

(73) Assignee: CHERVON LIMITED, Wanchai (HK)

(21) Appl. No.: 12/831,837

(22) Filed: Jul. 7, 2010

(30) Foreign Application Priority Data
May 11, 2010 (CN) 201020188332.4

(51) Int. Cl. B26D 7/00

(52) U.S. Cl. 83/699.51

(57) ABSTRACT

A working tool adapted for use with an oscillating tool includes a hole defining a longitudinal axis and has a plurality of bulges which depart from the longitudinal axis by a radial distance. Each of the bulges has two flanks that extend inwardly towards the longitudinal axis and which are connected with each other at a recess portion that is formed between every adjacent two of the bulges. An arc portion of one of the bulges has a length which is unequal to a length of an arc portion of the other one of the bulges. By arranging bulges with unequal arc lengths in the hole of the working tool, the working tool can be mounted to different oscillating tools at multiple angles and, by decreasing the number of the bulges, contact between the bulges and an output shaft of the oscillating tool reduces wear and increases the service life of the output shaft.

### RELATED APPLICATION INFORMATION

This application claims the benefit of CN 201020188332.4 filed on May 11, 2010 the disclosure of which is incorporated herein by reference in its entirety.

### BACKGROUND

Various multifunctional tools capable of being driven to output a right-and-left swinging or oscillating movement, i.e., an oscillating power tool, are known. A multifunctional tool usually works with a working tool that is capable of being connected in multiple different angles on a shaft end of an output shaft of the multifunctional tool by selectively engaging one or more holes of the working tool with one or more protrusions on the shaft end of the output shaft. The shapes of the holes of the working tool are different from each other, but generally can be divided into two type of arrangements. One type of arrangement has a plurality of securing holes which are located around the periphery of a central hole of the working tool and which do not communicate with the central hole wherein the arrangement functions to restrict the circumferential position of the working tool relative to the output shaft. The other type of arrangement has a plurality of securing bulges that are located along the outline of the central hole of the working tool wherein the arrangement likewise functions to restrict the circumferential position of the working tool relative to the output shaft.

By way of example, U.S. Pat. No. 6,796,888 disclosed a working tool of the other type noted above which comprises a center hole defining a longitudinal axis and having a plurality of securing bulges. Each of the bulges are distanced from the longitudinal axis by a radial distance and are connected to the adjacent bulge with flanks which forms a recess between every two adjacent bulges. The securing section of the working tool comprises at least six such securing bulges, every adjacent two of which are connected by the flanks extending towards the longitudinal axis and which converge to a common apex in the longitudinal axis.

However, the above described working tool has disadvantages. For example, because there are many protrusions on the shaft end of the output shaft for matching with the corresponding bulges of the working tool the sum engaging area between the working tool and the output shaft is large which increase the possibility of dead locking the working tool with the output shaft due to a deforming of the working tool during operation. In addition, due to the large contact area between the bulges of the working tool and the protrusions of the output shaft, the wearing speed of the bulges is increased which decreases the service life of the protrusions of the output shaft.

### SUMMARY

The subject disclosure is directed to a working tool that is adapted for use with an oscillating power tool which is particularly arranged to avoid dead locking with the shaft end of the output shaft due to a deforming of the working tool and to decrease the wearing of the protrusions on the shaft end of the output shaft so as to increase the service life of the output shaft.

To this end, the working tool comprises a hole defining a longitudinal axis and having a plurality of bulges where the bulges depart from the longitudinal axis by a radial distance and each of the bulges has two flanks extending towards the longitudinal axis and where the flanks connect to two adjacent bulges at recess portions formed between the bulges. An arc portion of one of the bulges formed between two flanks has a length which is not equal to a length of an arc portion of the other one of the bulges formed between two flanks. As will become apparent from the description that follows, by arranging a plurality of bulges with unequal arc lengths in the hole of the working tool the working tool can be mounted to various multifunctional tools in multiple different angles and, because the hole has fewer bulges, the contact with the bulges on the end of the output shaft decreases wearing with the service life of the output shaft thereby being increased. Similarly, because the hole has fewer bulges, the joining area between the working tool and the end of the shaft is decreased whereby the possibility of locking the working tool with the end of the shaft as a result of a deforming of the working tool is reduced. Still further, because a hole with the above features can be easily formed, the cost of molding is reduced and deforming problems in heat treatment are diminished.

### BRIEF DESCRIPTION OF THE DRAWINGS

FIG. 1 is a schematic view of a working tool adapted for use with an oscillating power tool constructed according to the description that follows;

FIG. 2 is a top view of the working tool shown in FIG. 1;

FIG. 3 is another schematic view of a working tool adapted for use with an oscillating power tool constructed according to the description that follows; and

FIG. 4 is yet another schematic view of a working tool adapt for use with an oscillating power tool constructed according to the description that follows.

### DETAILED DESCRIPTION

A working tool adapted for use with an oscillating tool is described in detail with reference to the accompanying drawings. For convenience of description, in the exemplary embodiment the working tool is in the form of a cutting tool.

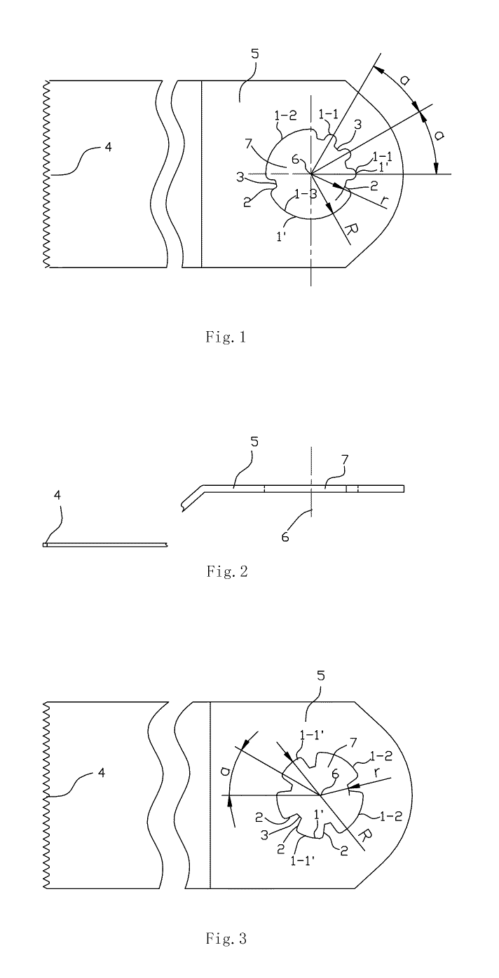

Referring to FIGS. 1 and 2, the cutting tool comprises a front cutting teeth portion 4 for cutting a work-piece and a rear connecting portion 5 adapt to be connected to the output shaft of the multifunctional tool. A hole 7 is formed in the connecting portion 5 and defines a longitudinal axis 6 that is substantially perpendicular to a plane in which the main body of the cutting tool lies. The hole 7 is formed with a plurality of bulges 1-1, 1-2, and 1-3 each of which is distanced from the longitudinal axis 6 by a radial distance R. Both sides of each of the bulges 1-1, 1-2, 1-3 have flanks 2 that extend inwardly towards the longitudinal axis 6 and which are connected with each other at recess portions 3 that are formed between every adjacent two of the bulges 1-1, 1-2, 1-3. Each of the recess portions 3 is departed from the longitudinal axis 6 by a radial distance r. Preferably, the number of the bulges 1-1, 1-2, 1-3 is five, wherein three adjacent bulges 1-1 have arc portions 1′ between two flanks of each of the three adjacent bulges 1-1, respectively, of equal length wherein the angles α between every two adjacent bulges 1-1 are thirty degrees. An arc portion 1′ of the bulge 1-2 formed between the two flanks of the bulge 1-2 and an arc portion l′ of the bulge 1-3 formed between the two flanks of the bulge 1-3 are neither of equal length with respect to each other nor of equal length with respect to the arc portions l′ of the bulges 1-1.

In this illustrated example, the angles α between every two adjacent bulges 1-1, 1-2, 1-3 are of thirty degrees. Thereby, the cutting tool has multi-angled mounting positions, that is, the cutting tool could be rotated towards the left or right by 30°, 60° or 90°, and then mounted to the output shaft of the multifunctional tool. In other embodiments, the angles α could be fifteen degrees or multiples of fifteen degrees and, as such, need not be limited to thirty degrees.

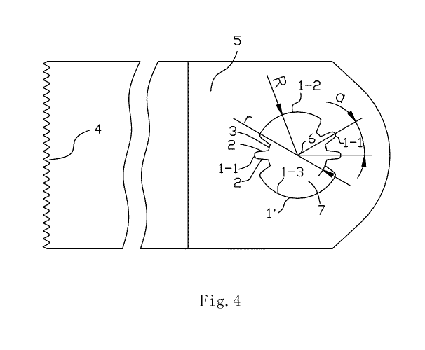

Comparing the cutting tool of FIGS. 3 and 4 to that of FIG. 1, the difference is only in the shape of the hole 7 in the connecting portion 5.

Comparing FIG. 3 with FIG. 1, it could be seen that the arc lengths of the three adjacent smaller bulges 1-1′ along the circumferential direction in FIG. 3 are longer than the arc lengths of the corresponding bulges shown in FIG. 1. Thus, when mounted to the end of the shaft, it is possible that more than one projection on the end of shaft can enter into a bulge 1-1′. Because the circumferential positioning of the cutting tool mainly depends on the positioning of the flanks on both sides of the bulges, the mounting angle is determined by the angle between the two flanks.

Comparing FIG. 4 with FIG. 1, it could be seen that the arrangement manner of the bulges are different. As shown in FIG. 4, two smaller bulges 1-1 with equal arc lengths are arranged adjacently and another smaller bulge 1-1 is arranged between the larger bulges 1-2 and 1-3 with unequal arc lengths.

While various embodiments of a working tool have been described in detail, it will be appreciated by those skilled in the art that various modifications and alternatives to these embodiments could be developed in light of the overall teachings of the disclosure. As such, the particular embodiments and arrangements that have been disclosed are meant to be illustrative only and not limiting as to the scope of the invention which is to be given the full breadth of the appended claims and any equivalents thereof.

What is claimed is:

1. A working tool adapt for use with an oscillating power tool, comprising:
a body;
a hole formed in the body defining a longitudinal axis and having a plurality of bulges wherein the bulges depart from the longitudinal axis by a radial distance and each of the bulges has two flanks that extend inwardly towards the longitudinal axis and which are connected with each other at a recess portion that is formed between every adjacent two of the bulges; and
wherein an arc portion of one of the bulges formed between two flanks of the one of the bulges has a length which is unequal to a length of an arc portion of an other one of the bulges formed between two flanks of the other one of the bulges.

2. The working tool according to claim 1, wherein a plurality of bulges comprise at least two bulges which have arc portions of equal length.

3. The working tool according to claim 2, wherein the two bulges having arc portions of equal length are adjacent to each other.

4. The working tool according to claim 1, wherein the plurality of bulges number five.

5. The working tool according to claim 4, wherein the five bulges comprise three adjacent bulges having arc portions of equal length.

6. The working tool according to claim 5, wherein the angles between every two adjacent bulges among the three adjacent bulges is a multiple of fifteen degrees.

7. The working tool according to claim 5, wherein the angles between every two adjacent bulges among the three adjacent bulges is thirty degrees.

8. The working tool according to claim 5, wherein a length of the arc portions of the remaining two bulges are unequal to the lengths of the arc portions of the three adjacent bulges.

9. The working tool according to claim 8, wherein the lengths of the arc portions of the remaining two bulges are unequal with respect to each other.
